(19) United States
(12) Patent Application Publication
(10) Pub. No.: US 2023/0270532 A1
(43) Pub. Date: Aug. 31, 2023

(54) INSTRUMENT HOLDER

(71) Applicant: TAKARA BELMONT CORPORATION, Osaka-shi, Osaka (JP)

(72) Inventors: Yuta NAKAO, Osaka (JP); Hiroyuki TERAYAMA, Osaka (JP)

(73) Assignee: TAKARA BELMONT CORPORATION, Osaka-shi, Osaka (JP)

(21) Appl. No.: 18/006,984

(22) PCT Filed: Jul. 19, 2021
(86) PCT No.: PCT/JP2021/026909

§ 371 Date: Jan. 26, 2023

(30) Foreign Application Priority Data
Jul. 27, 2020 (JP) 2020-126369

(51) Int. Cl. A61C 19/00

(52) U.S. Cl. CPC A61C 19/002

(57) ABSTRACT

Provided is an instrument holder that allows an instrument to be smoothly, safely, and hygienically handled by holding the instrument in a standing posture when in use and by holding the instrument in a posture not allowing the instrument to easily contact a practitioner when not in use. A holder portion 15 of an instrument holder 12 has a pair of supporting body portions 16, a rotational body portion 23 that is supported by the supporting body portions 16 and that is rotatable, and a holder body portion 31 that is attached to the rotational body portion 23. The holder portion 15 alternately changes between a rearwardly tilting holding state and a forwardly tilting waiting state due to rotation of the rotational body portion 23.

### TECHNICAL FIELD

The present invention relates to an instrument holder for holding an instrument that is used in dental treatment.

### BACKGROUND ART

Hitherto, a dental treatment device installed in a dental clinic has included an instrument holder holding an instrument. In general, since the instrument holder holds an instrument in a posture in which a head portion of the instrument faces a near side as seen from a dentist or a dental hygienist (hereunder referred to as “practitioner”), the head portion may come into contact with the practitioner or surrounding equipment. When a sharp edge, such as a cutting bar or a scaler tip, is attached to the head portion, contact of the edge with the practitioner is dangerous and unhygienic.

For example, the invention described in PTL 1 below (hereunder referred to as “invention known to the public through publication”) is one in which an instrument is held in a posture in which a head portion of the instrument faces a far side as seen from a practitioner. Specifically, the invention known to the public through publication is one in which an instrument holder is provided on a top surface of a flat-plate-shaped instrument fixed plate, and in which the instrument that is in a posture in which the head portion faces the far side is held in a horizontal posture by the instrument holder. Therefore, compared with when the instrument is held in a posture in which the head portion faces a near side, the probability of a practitioner coming into contact with the head portion is reduced, which is thus safer and hygienic.

### CITATION LIST

### Patent Literature

[PTL 1]
Japanese Patent No. 3587668

### SUMMARY OF INVENTION

### Technical Problem

However, since the invention known to the public through publication is, as described above, one in which the instrument is held in a horizontal state, a practitioner may have difficulty handling the instrument. That is, with the way the instrument is held differing according to practitioners, the ease of handling when a practitioner grasps the instrument held in a standing state and changes the way he holds the instrument in accordance with a medical treatment differs from the ease of handling when a practitioner grasps the instrument held in a horizontal state and changes the way he holds the instrument in accordance with a medical treatment.

The present invention has been proposed in view of the circumstances above. That is, it is an object to provide an instrument holder that allows an instrument to be smoothly, safely, and hygienically handled by allowing the instrument to be held in a standing posture when in use and by allowing the instrument to be held in a posture not allowing the instrument to easily contact a practitioner when not in use.

### Solution to Problem

To this end, an instrument holder according to the present invention has a holder portion that rotates from a rearwardly tilting holding state in a direction in which an instrument is brought into a forwardly tilting posture, and that is thereby brought into a forwardly tilting waiting state, the rearwardly tilting holding state being a state in which the holder portion holds the instrument in a rearwardly tilting posture in which an end of the instrument is tilted rearward, the forwardly tilting posture being a posture in which the end is tilted forward.

In an instrument holder according to the present invention, a plurality of the holder portions is separately rotatable.

An instrument holder according to the present invention has forward tilt angle adjusting means for adjusting a rotation angle of the holder portion.

In an instrument holder according to the present invention, in a state in which the instrument is removed from the holder portion in the forwardly tilting waiting state, the forwardly tilting waiting state is maintained.

In an instrument holder according to the present invention, in a state in which the instrument is held by the holder portion, the rearwardly tilting holding state is maintained.

In an instrument holder according to the present invention, a front surface of the holder portion is formed with an arc shape as seen from a direction of a rotation axis of the holder portion.

In an instrument holder according to the present invention, a front surface of the holder portion is provided with an operation portion upon which an external force for bringing the holder portion from the rearwardly tilting holding state to the forwardly tilting waiting state acts.

In an instrument holder according to the present invention, of the holder portion in the rearwardly tilting holding state, the operation portion is situated above a horizontal line passing through a rotation axis of the holder portion.

In an instrument holder according to the present invention, a detecting portion that detects presence or absence of the instrument is provided on a rotation axis of the holder portion or near the rotation axis.

In an instrument holder according to the present invention, the holder portion has a pair of supporting body portions that have a circular shape and that are coaxially disposed, a rotational body portion that is rotatably supported by the supporting body portions, and a holder body portion that is attached to the rotational body portion; and the holder body portion is provided with a cylindrical portion that has an insertion hole into which the instrument is to be inserted, an open portion where a front portion of the cylindrical portion is open and that communicates with the insertion hole, and a curved outer surface portion and a flat outer surface portion that are adjacent to each other in an up-down direction at locations forward of the open portion.

In an instrument holder according to the present invention, the holder portion has a roller that supports a hose of the instrument removed from the holder portion.

In an instrument holder according to the present invention, the forwardly tilting waiting state is maintained as a result of a center of gravity of the holder portion being situated forward of a rotation axis of the holder portion.

In an instrument holder according to the present invention, the holder portion is brought into the rearwardly tilting holding state from the forwardly tilting waiting state by holding the instrument at a position where a center of gravity of the instrument is situated rearward of a rotation axis of the holder portion.

### Advantageous Effects of Invention

The instrument holder according to the present invention has a holder portion that rotates from a rearwardly tilting holding state in a direction in which an instrument is brought into a forwardly tilting posture, and that is thereby brought into a forwardly tilting waiting state, the rearwardly tilting holding state being a state in which the holder portion holds the instrument in a rearwardly tilting posture in which an end of the instrument is tilted rearward, the forwardly tilting posture being a posture in which the end is tilted forward. That is, since, when the instrument is pulled out, the holder portion holds the instrument in the forwardly tilting posture, a practitioner is capable of smoothly pulling out the instrument. In addition, since, after the instrument has been pulled out, the holder portion waits for the instrument in the same posture as that when the instrument is pulled out, the practitioner is capable of smoothly returning the instrument. Further, even after the practitioner has returned the instrument, the holder portion is capable of maintaining the forwardly tilting waiting state while holding the instrument. On the other hand, since, when the instrument is not in use, the holder portion holds the instrument in the rearwardly tilting posture not allowing the practitioner to easily contact the instrument, the practitioner is capable of safely and hygienically handling the instrument.

In the instrument holder according to the present invention, a plurality of the holder portions is separately rotatable. That is, by individually rotating each holder portion and bringing each holder portion into the forwardly tilting waiting state or the rearwardly tilting holding state, only an instrument that is to be used is brought into the forwardly tilting posture, and the other instrument or instruments that are not used are maintained in the rearwardly tilting posture. Therefore, a plurality of instruments can individually be smoothly, safely, and hygienically handled in accordance with whether or not they are to be used.

The instrument holder according to the present invention has forward tilt angle adjusting means for adjusting a rotation angle of the holder portion in the forwardly tilting waiting state. Therefore, a practitioner is capable of adjusting the holder portion in the forwardly tilting waiting state to an angle that allows the practitioner to easily grasp the instrument.

In the instrument holder according to the present invention, in a state in which the instrument is removed from the holder portion, the forwardly tilting waiting state is maintained. That is, even after the instrument has been removed, the forwardly tilting waiting state continues. In the forwardly tilting waiting state, since the holder portion faces a direction that allows the holder portion to receive the instrument in the forwardly tilting posture, a practitioner is capable of easily returning the instrument to the holder portion and smoothly handling the instrument.

In the instrument holder according to the present invention, in a state in which the instrument is held by the holder portion, the rearwardly tilting holding state is maintained. That is, the holder portion holding the instrument maintains the rearwardly tilting holding state. In the rearwardly tilting holding state, since the instrument is in the rearwardly tilting posture and is unlikely to come into contact with a practitioner, the practitioner is capable of easily and hygienically handling the instrument.

In the instrument holder according to the present invention, a front surface of the holder portion is formed with an arc shape as seen from a direction of a rotation axis of the holder portion. Due to this structure, even if an external force is applied to the front surface of the holder portion, the state of the holder portion is unlikely to change. That is, for example, in the forwardly tilting waiting state, even when a hose or the body of a practitioner has come into contact with a front portion of the holder portion when the practitioner returns the instrument to the holder portion, since the front portion is curved, a force that rotates the holder portion is unlikely to be generated and the holder portion is unlikely to be brought into the rearwardly tilting holding state. Therefore, the holder portion is maintained in the forwardly tilting waiting state without rotating.

In the instrument holder according to the present invention, a front surface of the holder portion is provided with an operation portion upon which an external force for bringing the holder portion from the rearwardly tilting holding state to the forwardly tilting waiting state acts. That is, the holder portion is brought into the forwardly tilting waiting state from the rearwardly tilting holding state due to the action of an external force upon the operation portion. For example, even when the holder portion is unintentionally brought into the rearwardly tilting holding state from the forwardly tilting waiting state, a practitioner is capable of bringing the holder portion into the forwardly tilting waiting state by bringing his finger into contact with the operation portion.

In the instrument holder according to the present invention, of the holder portion in the rearwardly tilting holding state, the operation portion is situated above a horizontal line passing through a rotation axis of the holder portion. Due to this structure, for example, a finger or a hose of the instrument tends to come into contact with the operation portion. That is, it can be considered that when a practitioner operates the operation portion, the practitioner frequently pushes the operation portion downward from an upper side. Here, for example, if the holder portion is unintentionally brought into the rearwardly tilting holding state from the forwardly tilting waiting state, when, of the holder portion in the rearwardly tilting holding state, the operation portion is situated above the horizontal line passing through the rotation axis of the holder portion, the practitioner can easily operate the operation portion with his finger, and, in the process of an operation of accommodating a hose in the holder portion, the instrument or the hose can be made to come into contact with the operation portion, as a result of which the holder portion is brought into the forwardly tilting waiting state.

In the instrument holder according to the present invention, a detecting portion that detects presence or absence of the instrument is provided on a rotation axis of the holder portion or near the rotation axis. Since the holder portion by rotating is brought into the rearwardly tilting holding state or the forwardly tilting waiting state, with the posture of the holder portion differing for each state, the rotation axis does not change even if the state of the holder portion is either the rearwardly tilting holding state or the forwardly tilting waiting state. That is, if the position of the detecting portion is situated away from the rotation axis, the position of the detecting portion with respect to the rotation axis is displaced each time the state of the holder portion changes, as a result of which wiring of the detecting portion becomes troublesome, whereas, when the position of the detecting portion is near the rotation axis as in the present invention, the wiring of the detecting portion is facilitated.

In the instrument holder according to the present invention, the holder portion has a pair of supporting body portions that have a circular shape and that are coaxially disposed, a rotational body portion that is rotatably supported by the supporting body portions, and a holder body portion that is attached to the rotational body portion; and the holder body portion is provided with a cylindrical portion that has an insertion hole into which the instrument is to be inserted, an open portion where a front portion of the cylindrical portion is open and that communicates with the insertion hole, and a curved outer surface portion and a flat outer surface portion that are adjacent to each other in an up-down direction at locations forward of the open portion. That is, since the front portion of the insertion hole is open, a practitioner is capable of inserting a hose into the insertion hole from a forward side. In addition, for example, even if, in the forwardly tilting waiting state, the body of the practitioner has come into contact with the curved outer surface portion, since the curved outer surface portion is curved, a force that rotates the holder portion is unlikely to be generated and the holder portion maintains the forwardly tilting waiting state without rotating. In addition, for example, even if the holder portion has unintentionally been brought into the rearwardly tilting holding state from the forwardly tilting waiting state, the practitioner is capable of bringing the holder portion into the forwardly tilting waiting state by bringing, for example, his finger or a hose of the instrument into contact with the flat outer surface portion.

In the instrument holder according to the present invention, the holder portion has a roller that supports a hose of the instrument removed from the holder portion. Due to this structure, since the hose is supported by the roller and a load is distributed due to the rotation of the roller, the ability to operate the instrument is increased and the burden on a practitioner when pulling the instrument is reduced. In addition, since the hose passes between the holder portion and the roller, when the instrument is pulled out or returned, a path of the hose is restricted to the inside of the holder portion and thus the hose is not removed from the holder portion. Therefore, the practitioner can easily return the instrument.

In the instrument holder according to the present invention, the forwardly tilting waiting state is maintained as a result of a center of gravity of the holder portion being situated forward of a rotation axis of the holder portion. Due to this structure, the holder portion maintains the forwardly tilting waiting state by gravitation acting upon the center of gravity. As long as an external force exceeding the gravitation that acts upon the center of gravity does not act, the forwardly tilting waiting state continues. Therefore, the holder portion is suppressed from unintentionally being brought into the rearwardly tilting holding state.

In the instrument holder according to the present invention, the holder portion is brought into the rearwardly tilting holding state from the forwardly tilting waiting state by holding the instrument at a position where a center of gravity of the instrument is situated rearward of a rotation axis of the holder portion. Due to this structure, by gravitation that acts upon the center of gravity of the instrument, the holder portion holding the instrument is automatically brought into the rearwardly tilting holding state from the forwardly tilting waiting state, and maintains the rearwardly tilting holding state. Therefore, since the instrument is not held in the forwardly tilting posture in which the instrument may contact a practitioner, the practitioner is capable of safely and hygienically handling the instrument.

### BRIEF DESCRIPTION OF DRAWINGS

FIG. 1 is an external perspective view showing a dental treatment device according to a first embodiment of the present invention.

FIG. 2 is an external perspective view when, in an instrument holder according to the first embodiment of the present invention, holder portions are in a rearwardly tilting holding state.

FIG. 3 is an external perspective view when, in the instrument holder according to the first embodiment of the present invention, a holder portion is in a forwardly tilting waiting state.

FIG. 4 is an external perspective view when, in the instrument holder according to the first embodiment of the present invention, the holder portion is in the forwardly tilting waiting state and an instrument has been pulled out.

FIG. 5 is an external perspective view of the instrument holder according to the first embodiment of the present invention.

FIG. 6 is an enlarged exploded perspective view of the instrument holder according to the first embodiment of the present invention.

FIG. 7 is a side sectional view along VII-VII of FIG. 5 when a holder portion of the instrument holder according to the first embodiment of the present invention is in the forwardly tilting waiting state.

FIG. 8 is a side sectional view along VIII-VIII of FIG. 5 when the holder portion of the instrument holder according to the first embodiment of the present invention is in the rearwardly tilting holding state.

FIG. 9 is a partial exploded side view when the holder portion of the instrument holder according to the first embodiment of the present invention is in the rearwardly tilting holding state.

FIG. 10 is a partial exploded side view when the holder portion of the instrument holder according to the first embodiment of the present invention is in the forwardly tilting waiting state.

FIG. 11 is a side sectional view when a holder portion of an instrument holder according to a second embodiment of the present invention is in a forwardly tilting waiting state, showing a first mode in forward tilt angle adjusting means.

FIG. 12 is a side sectional view when the holder portion of the instrument holder according to the second embodiment of the present invention is in the forwardly tilting waiting state, showing a second mode in the forward tilt angle adjusting means.

FIG. 13 is a partial exploded side view when a holder portion of an instrument holder according to a third embodiment of the present invention is in a rearwardly tilting holding state.

FIG. 14 is a partial exploded side view when the holder portion of the instrument holder according to the third embodiment of the present invention is in a forwardly tilting waiting state.

FIG. 15 is a schematic side sectional view when a holder portion of an instrument holder according to a fourth embodiment of the present invention is in a rearwardly tilting holding state.

FIG. 16 is a schematic side sectional view when the holder portion of the instrument holder according to the fourth embodiment of the present invention is in a forwardly tilting waiting state.

FIG. 17 is an external perspective view of an instrument holder according to a fifth embodiment of the present invention.

FIG. 18 is a side sectional view along XVIII-XVIII of FIG. 17 when a holder portion of the instrument holder according to the fifth embodiment of the present invention is in a rearwardly tilting holding state.

FIG. 19 is a side sectional view when the holder portion of the instrument holder according to the fifth embodiment of the present invention is in a forwardly tilting waiting state.

FIG. 20 is a side sectional view along XX-XX of FIG. 17 when the holder portion of the instrument holder according to the fifth embodiment of the present invention is in the forwardly tilting waiting state.

### DESCRIPTION OF EMBODIMENTS

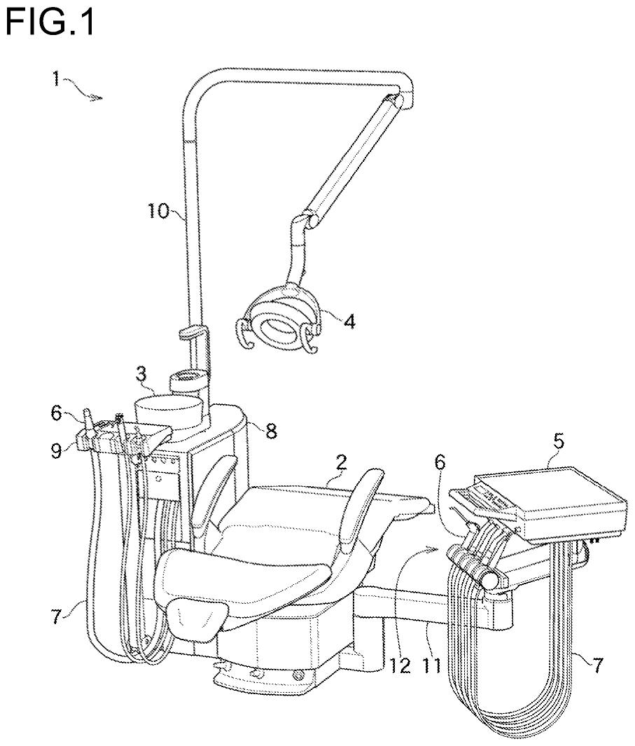

The following is a description of an instrument holder according to a first embodiment of the present invention. FIG. 1 is an external view of a dental treatment device 1 having an instrument holder 12.

As shown in FIG. 1, the dental treatment device 1 has a treatment seat 2 where a patient (not shown) lies, a spittoon 3 for allowing the patient to spit out water in his mouth, a dental light 4 that illuminates the mouth of the patient, and a doctor table 5 used by a practitioner to perform surgery. The instrument holder 12 holding various instruments 6 is attached to the doctor table 5.

The spittoon 3 and the dental light 4 are supported by a cuspidor unit 8. The cuspidor unit 8 is installed next to the treatment seat 2. The spittoon 3 is a bowl and is installed on the cuspidor unit 8. The dental light 4 is connected to an end of a light movable arm 10 attached to the cuspidor unit 8. The cuspidor unit 8 has a subholder 9 that holds instruments 6. The doctor table 5 is connected to an end of a table movable arm 11 attached to the vicinity of the treatment seat 2. The light movable arm 10 and the table movable arm 11 have a plurality of joints. Therefore, the dental light 4 is capable of moving freely by means of the light movable arm 10. The doctor table 5 is capable of moving freely by means of the table movable arm 11.

The instruments 6 held by the subholder 9 and the instruments 6 held by the instrument holder 12 are, for example, turbines, micromotors, air motors, scalers, or syringes. Instrument hoses 7 are connected to the instruments 6, and the instrument hoses 7 are connected to the doctor table 5 or the cuspidor unit 8.

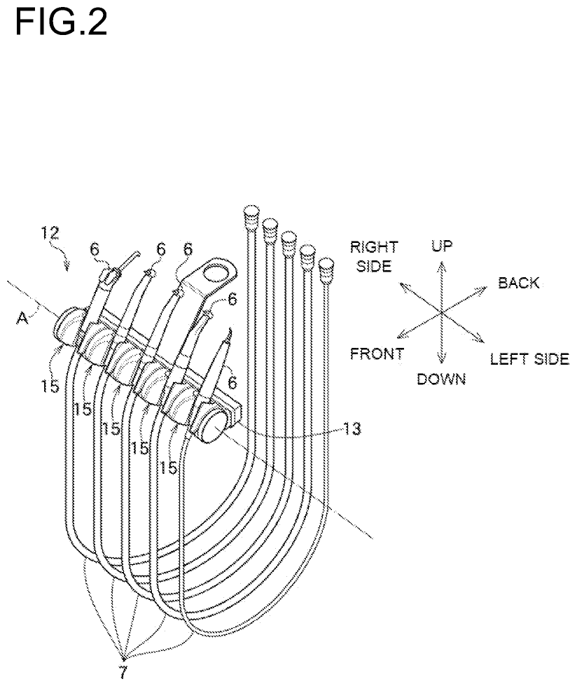

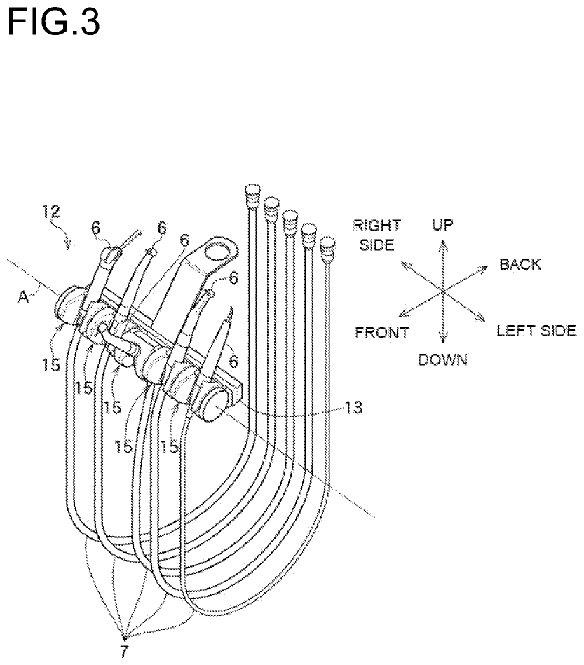

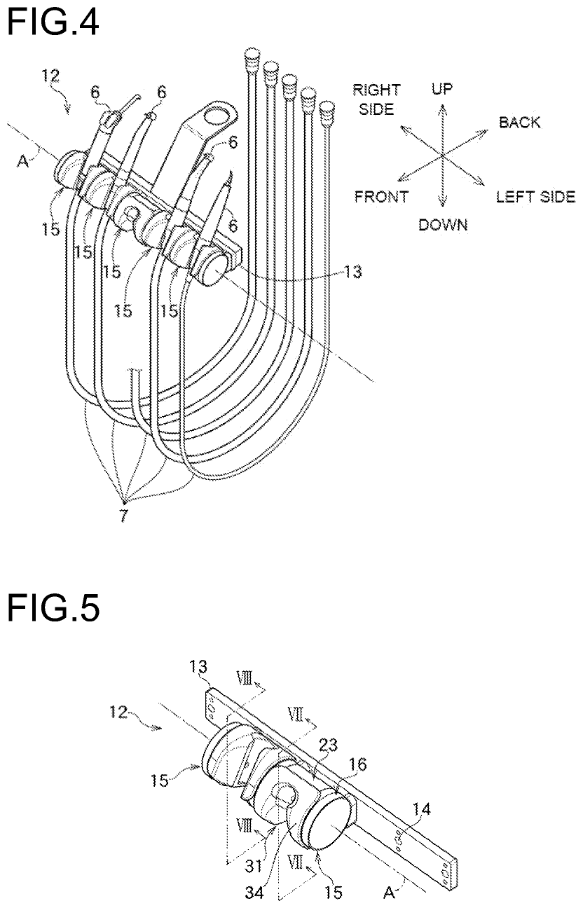

Here, the instrument holder 12 is described on the basis of the drawings. FIGS. 2, 3, and 4 show the process of operations of the instrument holder 12. FIG. 2 shows a rearwardly tilting holding state in which the instruments 6 can be held in a rearwardly tilting posture that is a posture in which an end of each instrument 6 is tilted rearward; FIG. 3 shows a forwardly tilting waiting state in which an instrument 6 can be held in a forwardly tilting posture that is a posture in which an end of the instrument 6 is tilted forward; and FIG. 4 shows, in the forwardly tilting waiting state, the state of the instrument 6 in a waiting state after the instrument 6 has been pulled out from the instrument holder 12. Note that, in the description below, as shown in FIGS. 2, 3, and 4, a direction in which the ends of the instruments 6 are tilted toward the doctor table 5 or a side closer to the doctor table 5 than a rotation axis A is defined as back; an opposite side thereto, a direction in which the ends of the instruments 6 are tilted toward a practitioner (not shown), or a side closer to the practitioner than the rotation axis A is defined as front; directions in which the plurality of instruments 6 is disposed side by side are defined as left side and right side; a direction in which gravitation acts is defined as down; and a direction opposite thereto is defined as up.

As shown in FIGS. 2, 3, and 4, the instrument holder 12 is one in which a plurality of holder portions 15 is attached to a base portion 13 having a long plate shape. Each holder portion 15 alternately changes between the rearwardly tilting holding state and the forwardly tilting waiting state by rotating, and causes a corresponding one of the instruments 6 to change to the rearwardly tilting posture or the forwardly tilting posture. The holder portions 15 are disposed side by side on the same rotation axis A in a left-right direction, and are capable of rotating separately. Although the number of holder portions 15 is any number, in the present embodiment, five holder portions 15 are used.

As shown in FIG. 2, the holder portions 15 in the rearwardly tilting holding state hold the instruments 6 in the rearwardly tilting posture, and maintain the rearward tilting holding state. Therefore, the ends of the instruments 6 are situated away from the side where a practitioner exists, and face the side where the doctor table 5 exists. In this state, when the practitioner pushes an instrument 6 forward and thus an external force acts upon the instrument 6, the instrument 6 falls forward and the holder portion 15 rotates forward, as a result of which, as shown in FIG. 3, the holder portion 15 is brought into the forwardly tilting waiting state. The holder portion 15 in the forwardly tilting waiting state holds the instrument 6 in the forwardly tilting posture. Therefore, the end of the instrument 6 moves away from the side where the doctor table 5 exists and faces the side where the practitioner exists. In this state, when the practitioner grasps the instrument 6 and pulls it out from the holder portion 15, as shown in FIG. 4, the holder portion 15 maintains the forwardly tilting waiting state. The holder portion 15 in the forwardly tilting waiting state is capable of receiving the instrument 6 in the forwardly tilting posture.

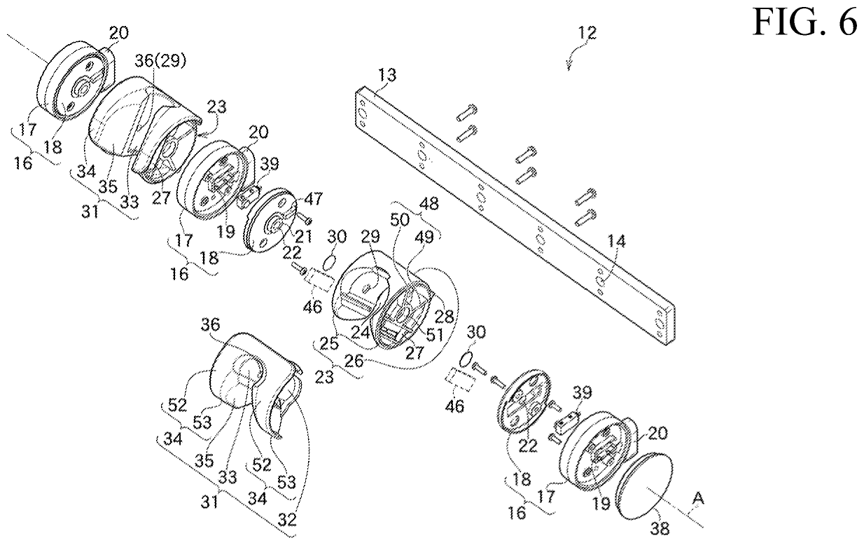

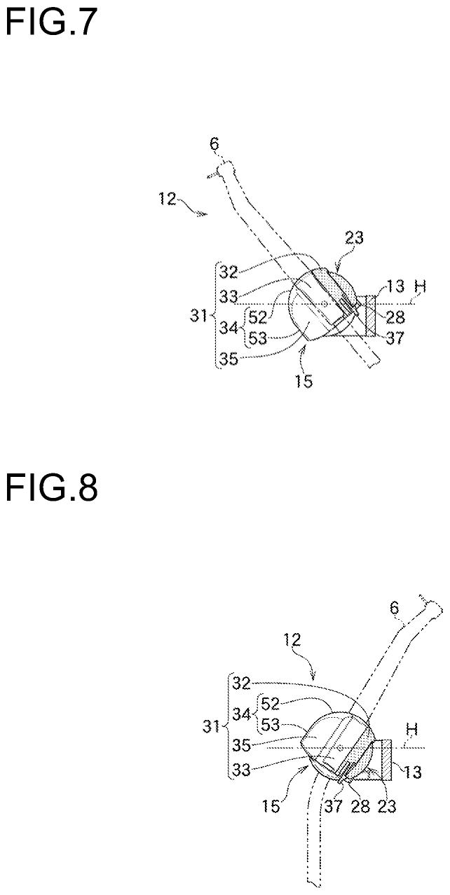

Further, the instrument holder 12 is described in more detail on the basis of the drawings. FIG. 5 is an external view of the instrument holder 12 in the rearwardly tilting holding state and the forwardly tilting waiting state, and FIG. 6 is an exploded view of the instrument holder 12 in each state. FIGS. 7 and 8 each show a cross section of the instrument holder 12.

As shown in FIG. 5 and FIG. 6, the instrument holder 12 includes the base portion 13 and the holder portions 15 fixed to a front surface of the base portion 13. Through wire holes 14, into which wires are to be inserted, are formed in the base portion 13 for the corresponding holder portions 15. Screw holes through which, for example, screws for fixing the holder portions 15 are passed are formed as appropriate in the base portion 13. Each holder portion 15 has a pair of supporting body portions 16 that are fixed to the base portion 13, a rotational body portion 23 that is supported by the supporting body portions 16 and that is rotatable with respect to the supporting body portions 16, a holder body portion 31 that is attached to the rotational body portion 23, detecting portions 39 that are built in the respective supporting body portions 16 and that detect presence or absence of a corresponding one of the instruments 6, and angular positioning means that determines the rotation angle of the rotational body portion 23. Each detecting portion 39 is, for example, an infrared sensor. Note that a weight 46 is state maintaining means of a second embodiment described below. The state maintaining means is a structure for forcefully maintaining the rearwardly tilting holding state or the forwardly tilting waiting state. The first embodiment does not have state maintaining means.

The pair of supporting body portions 16 have a disk shape, and each further include a pair of members. Each supporting body portion 16 includes a disc-shaped fixed-side supporting body portion 17 and a cover-side supporting body portion 18 that has a disk shape being the same as that of the fixed-side supporting body portion 17, and that is attached to the fixed-side supporting body portion 17. Detecting-portion accommodation portions 19 to which a corresponding one of the detecting portions 39 is attached are formed at substantially the center on inner sides of the respective fixed-side supporting body portions 17. Connection portions 20 that are attached to the base portion 13 are formed on outer peripheral surfaces of the respective fixed-side supporting body portions 17. The connection portions 20 protrude rearward from the respective outer peripheral surfaces. The connection portions 20 and the fixed-side supporting body portions 17 communicate with each other on inner sides thereof, and electric wires and signal wires of the detecting portions 39 are passed through the connection portions 20. At the fixed-side supporting body portions 17, the cover-side supporting body portions 18 are each attached to a side surface of a corresponding one of the fixed-side supporting body portions 17 from a side facing the rotational body portion 23. Axial protrusions 21 that become the rotation axis A when the rotational body portion 23 is rotated are formed at the center of the respective cover-side supporting body portions 18. The axial protrusions 21 protrude toward the rotational body portion 23. Supporting-body window portions 22 are formed at the respective axial protrusions 21 at the centers of the respective cover-side supporting body portions 18. The supporting-body window portions 22 each have a hole extending through a corresponding one of the axial protrusions 21 in an axial direction. At the cover-side supporting body portions 18, positioning protrusions 47 serving as angular positioning means are formed on the side facing the rotational body portion 23. The positioning protrusions 47 protrude toward the rotational body portion 23, and are disposed behind the rotation axis A in the vicinity of the respective axial protrusions 21.

The external appearance of the rotational body portion 23 has a columnar shape suitable for rotation with the left and right thereof as axes. In this column, in a direction orthogonal to the rotation axis A, a mount hole 24 to which the holder body portion 31 is to be attached is formed and a forward side of the mount hole 24 is open. That is, the rotational body portion 23 has a pair of support portions 25 that are supported by the supporting body portions 16, and a back surface portion 26 that consecutively connects back portions of the respective support portions 25 to each other. Front portions of the respective support portions 25 are separated from each other and are not consecutively connected to each other. The support portions 25 are such that a left outer surface and a right outer surface are circular. Axial recessed portions 51, weight accommodation portions 27, and positioning groove portions 48 serving as angular positioning means are formed on inner sides of the respective support portions 25. The axial recessed portions 51 are circular grooves formed in the centers of the outer surfaces of the respective support portions 25. The weight accommodation portions 27 are situated forward of the axial recessed portions 51 (the rotation axis A). The positioning groove portions 48 are situated rearward of the axial recessed portions 51, and each include a first positioning portion 49 and a second positioning portion 50. Each of the positioning portions 49 and 50 has a flat plate shape, and extends radially rearward from the axial recessed portion 51. A space is formed between the positioning portions 49 and 50. The back surface portion 26 is curved with the axial recessed portions 51 as centers. The back surface portion 26 is provided with a retain portion 28 protruding rearward (see FIG. 7 and FIG. 8). The mount hole 24 is orthogonal to the axial recessed portions 51, and the center of the mount hole 24 is substantially orthogonal to the axial recessed portions 51. On an inner side of the rotational body portion 23 (the mount hole 24), a rotational body window portion 29 is formed at the center between the support portions 25 and above the axial recessed portions 51. The rotational body window portion 29 is a hole extending through the rotational body portion 23 in a direction of the axial recessed portions 51. For example, transmissive members 30 made of glass, plastic, or the like are attached to the rotational body window portion 29 from left and right outer sides.

As shown in FIGS. 6, 7, and 8, the holder body portion 31 has a cylindrical portion 32 that has an insertion hole 33 into which an instrument 6 is to be inserted, a cover portion 34 that is consecutively connected to an upper end of the cylindrical portion 32 and that extends up to a forward side of the cylindrical portion 32, and a flat open portion 35 where a front portion of the cylindrical portion 32 is open and that communicates with the insertion hole 33. The cylindrical portion 32 has a shape that follows the shape of the mount hole 24 of the rotational body portion 23. With the forward side of the cylindrical portion 32 being open, the cylindrical portion 32 is formed with a C shape as seen from an axial direction of the insertion hole 33. The center of the insertion hole 33 is substantially orthogonal to the rotation axis A. A holder window portion 36 is formed on the rotation axis A at an inner surface of the cylindrical portion 32. The holder window portion 36 is a hole extending through the holder body portion 31 in a direction of the rotation axis A. A retaining piece 37 that retains the rotational body portion 23 is formed at a lower end of the cylindrical portion 32. The cover portion 34 is a flange extending sideways leftward and rightward, and rearward and forward from the upper end of the cylindrical portion 32. A front surface of the cover portion 34 extends up to the lower end of the cylindrical portion 32 from a left portion and a right portion, and is consecutively connected to the open portion 35. The open portion 35 is consecutively connected to a front portion of the cover portion 34 and is formed to extend far back from the front portion toward the insertion hole 33. The open portion 35 extends along the axial direction of the insertion hole 33. As shown in FIG. 7 and FIG. 8, the cover portion 34 has a curved outer surface portion 52 that is consecutively connected to a front portion and an upper portion of the open portion 35, and a flat outer surface portion 53 serving as an operation portion that is consecutively connected to a lower portion of the curved outer surface portion 52 and to the front portion of the open portion 35. The curved outer surface portion 52 is formed to be curved with an arc shape as seen from the direction of the rotation axis A. The flat outer surface portion 53 is formed to be flat as seen from the direction of the rotation axis A. When a holder portion 15 is in the forwardly tilting waiting state, the curved outer surface portion 52 is disposed above a horizontal line H passing through the rotation axis A (see FIG. 7). On the other hand, when the holder portion 15 is in the rearwardly tilting holding state, the flat outer surface portion 53 is disposed above the horizontal line H passing through the rotation axis A (see FIG. 8).

Each member formed as described above is assembled as follows.

In FIG. 6, the detecting portions 39 are attached to the respective detecting-portion accommodation portions 19 at the fixed-side supporting body portions 17 of the respective supporting body portions 16, and a wire of each detecting portion 39 is passed through the connection portion 20 at a corresponding one of the fixed-side supporting body portions 17. The cover-side supporting body portions 18 of the respective supporting body portions 16 are each attached to a corresponding one of the fixed-side supporting body portions 17. The transmissive members 30 are attached from the left and right outer sides to the rotational body window portion 29 of the rotational body portion 23. The supporting body portions 16 are attached from the left and right outer sides to a corresponding one of the two support portions 25 of the rotational body portion 23, and the axial protrusions 21 of the respective supporting body portions 16 are inserted into a corresponding one of the axial recessed portions 51 of the two support portions 25. Here, the positioning protrusions 47 of the respective supporting body portions 16 are disposed between the positioning portions 49 and 50 of the rotational body portion 23. The rotational body portion 23 is supported by being sandwiched by the two supporting body portions 16 and is freely rotatable. The supporting body portions 16 and the rotational body portion 23 are disposed on the rotation axis A. An assembled holder portion 15 is fixed to the base portion 13. Here, the wires of the detecting portions 39 passing through the connection portions 20 are passed through the through wire holes 14 of the base portion 13. If a plurality of holder portions 15 is to be fixed to the base portion 13, rotational body portions 23 that are adjacent to each other are supported by common supporting body portions 16. Of the adjacent holder portions 15, a decorative cover 38 is attached to the endmost supporting body portion 16.

Next, the holder body portion 31 is attached to the rotational body portion 23. Here, the cylindrical portion 32 of the holder body portion 31 is inserted into the mount hole 24 of the rotational body portion 23, and the retaining piece 37 of the holder body portion 31 is retained by a lower edge of the mount hole 24. The rotational body portion 23 and the supporting body portions 16 are covered over their entire surfaces from their top surfaces by the cover portion 34 of the holder body portion 31 (see FIG. 5). The supporting-body window portions 22 of the supporting body portions 16, the rotational body window portion 29 of the rotational body portion 23, and the holder window portion 36 of the holder body portion 31 are lined up on the rotation axis A, and infrared light sources and light receiving elements of the detecting portions 39 are also disposed on the rotation axis A.

Here, since the center of the insertion hole 33 of the holder body portion 31 is substantially orthogonal to the rotation axis A, if, in a state in which an instrument 6 is inserted into the insertion hole 33 and is held by the holder portion 15, the weight of the holder portion 15 can be ignored, the center of gravity of the holder portion 15 including the instrument 6 (hereunder referred to as “holder portion with instrument”) is disposed at the instrument 6. The instrument 6 is held by the holder portion 15 so that the center of gravity of the holder portion with instrument is situated above the rotation axis A. Therefore, when an external force acts upon the instrument 6 rearward from the rotation axis A, or when an end of the instrument 6 is situated behind the rotation axis A, the center of gravity is situated behind the rotation axis A, and the moment that acts upon the holder portion with instrument is in a direction of rearward rotation of the rotational body portion 23 (for example, clockwise in FIG. 7). Consequently, the holder portion 15 is brought into the rearwardly tilting holding state. The rearwardly tilting holding state is maintained due to the action of gravitation. On the other hand, when an external force acts upon the instrument 6 forward from the rotation axis A, or when the end of the instrument 6 is situated forward of the rotation axis A, the center of gravity is situated forward of the rotation axis A, and the moment that acts upon the holder portion with instrument is in a direction of forward rotation of the rotational body portion 23 (for example, counterclockwise in FIG. 8). Therefore, the holder portion 15 is brought into the forwardly tilting waiting state. The forwardly tilting waiting state is maintained due to the action of gravitation. Even when, in the forwardly tilting waiting state, the instrument 6 has been pulled out, as long as an external force does not act, the forwardly tilting waiting state of the holder portion 15 is maintained.

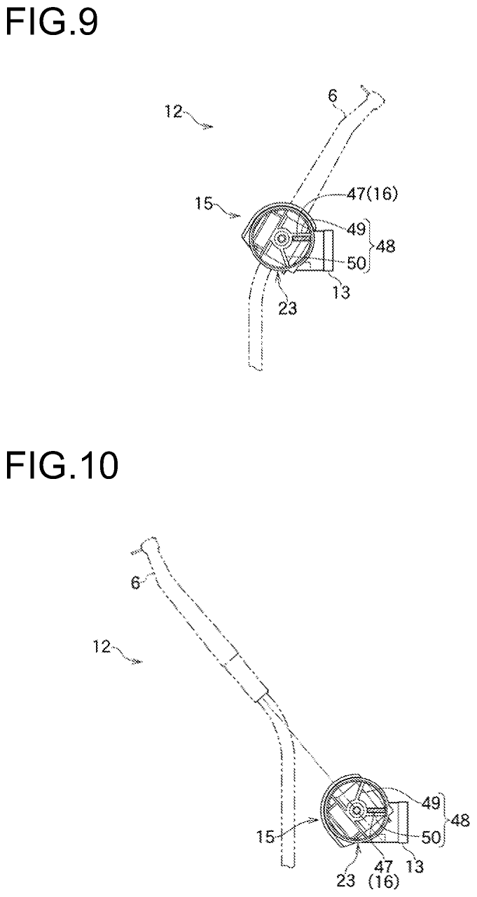

Here, the rotation angle of the holder portion 15 is determined by the angular positioning means. FIG. 9 and FIG. 10 show the angular positioning means of the instrument holder 12. FIG. 9 shows the inside of the instrument holder 12 that has been brought into the rearwardly tilting holding state by the angular positioning means, and FIG. 10 shows the inside of the instrument holder 12 that has been brought into the forwardly tilting waiting state by the angular positioning means.

In FIG. 9, with the moment that acts upon the holder portion with instrument being in the direction of the rearward rotation of the rotational body portion 23 (for example, clockwise in FIG. 9), since the first positioning portions 49 of the rotational body portion 23 abut upon the positioning protrusions 47 of the respective supporting body portions 16, the rotational body portion 23 is stopped. Therefore, the rearwardly tilting holding state is maintained. On the other hand, in FIG. 10, with the moment that acts upon the holder portion with instrument being in the direction of the forward rotation of the rotational body portion 23 (for example, counterclockwise in FIG. 10), since the second positioning portions 50 of the rotational body portion 23 abut upon the positioning protrusions 47, the rotational body portion 23 is stopped. Therefore, the forwardly tilting waiting state is maintained.

The first embodiment is constituted as described above.

Next, the effects of the first embodiment are described.

As described above, in the present embodiment, a holder portion 15 of the instrument holder 12 has a pair of supporting body portions 16 that are fixed to the base portion 13, a rotational body portion 23 that is supported by the supporting body portions 16 and that is rotatable with respect to the supporting body portions 16, and a holder body portion 31 that is attached to the rotational body portion 23 (see FIG. 5). That is, as a result of rotating the rotational body portion 23, the holder portion 15 alternately changes its state between the rearwardly tilting holding state and the forwardly tilting waiting state, and each state is maintained. The holder portion 15 in the rearwardly tilting holding state holds an instrument 6 in the rearwardly tilting posture not allowing the instrument 6 to easily contact a practitioner. Therefore, the practitioner is capable of safely and hygienically handling the instrument 6. On the other hand, since the holder portion 15 in the forwardly tilting waiting state holds the instrument 6 in the forwardly tilting posture, the practitioner is capable of smoothly pulling out the instrument 6. In addition, since, after the instrument 6 has been pulled out, the holder portion 15 maintains the forwardly tilting waiting state, the practitioner is capable of easily returning the instrument 6 to the holder portion 15 and smoothly handling the instrument 6. Further, even after returning the instrument 6, the practitioner is capable of allowing the instrument 6 to be held in the forwardly tilting waiting state in accordance with use.

In the present embodiment, a holder body portion 31 has a cylindrical portion 32 that has an insertion hole 33 into which an instrument 6 is to be inserted, a cover portion 34 that is consecutively connected to an upper end of the cylindrical portion 32 and that extends up to a forward side of the cylindrical portion 32, and a flat open portion 35 where a front portion of the cylindrical portion 32 is open and that communicates with the insertion hole 33 (see FIG. 7). The cylindrical portion 32 is formed with a C shape as seen from an axial direction of the insertion hole 33. Due to this structure, a practitioner is capable of inserting an instrument hose 7 into the insertion hole 33 from a forward side through the open portion 35. Here, the cover portion 34 has a flat outer surface portion 53 that is consecutively connected to a front portion of the open portion 35 and that is flat as seen from the direction of the rotation axis A. Therefore, for example, in the forwardly tilting waiting state, even when the holder portion 15 is unintentionally brought into the rearwardly tilting holding state as a result of some external force acting upon the holder portion 15 (see FIG. 8), the holder portion 15 can be brought into the forwardly tilting waiting state when a practitioner touches the flat outer surface portion 53 with his finger, or when the instrument hose 7 is made to contact the open portion 35.

In particular, in the rearwardly tilting holding state, the flat outer surface portion 53 is disposed above the horizontal line H passing through the rotation axis A (see FIG. 8). That is, it can be considered that when a practitioner operates the flat outer surface portion 53, the practitioner frequently pushes the flat outer surface portion 53 downward from an upper side. Here, for example, even if the holder portion 15 is unintentionally brought into the rearwardly tilting holding state from the forwardly tilting waiting state, when, of the holder portion 15 in the rearwardly tilting holding state, the flat outer surface portion 53 is situated above the horizontal line H passing through the rotation axis A, the holder portion 15 is brought into the forwardly tilting waiting state as a result of the practitioner touching the flat outer surface portion 53 with his finger. Therefore, the practitioner is capable of bringing the holder portion 15 into the forwardly tilting waiting state by operating the rotational body portion 23.

In the present embodiment, the cover portion 34 of the holder body portion 31 has a curved outer surface portion 52 that is consecutively connected to a front portion and an upper portion of the open portion 35, and that is curved with an arc shape as seen from the direction of the rotation axis A (see FIG. 8). Due to this structure, even if, in the forwardly tilting waiting state, an instrument hose 7 or the body of a practitioner comes into contact with a front portion of the holder body portion 31 when the practitioner returns the instrument 6 to the holder portion 15, since the front portion of the holder body portion 31 is curved, a force that rotates the holder portion 15 is unlikely to be generated and the holder portion 15 is unlikely to be brought into the rearwardly tilting holding state. Therefore, the state of the holder portion 15 is unlikely to change, and the holder portion 15 maintains the forwardly tilting waiting state without rotating.

In the present embodiment, each supporting body portion 16 of a holder portion 15 includes a fixed-side supporting body portion 17 and a cover-side supporting body portion 18; and the detecting portions 39 that detect presence or absence of an instrument 6 are attached to respective detecting-portion accommodation portions 19 formed at substantially the centers on the inner sides of the respective fixed-side supporting body portions 17 (see FIG. 6). Each detecting portion 39 is, for example, an infrared sensor. The supporting-body window portions 22 of the supporting body portions 16, the rotational body window portion 29 of the rotational body portion 23, and the holder window portion 36 of the holder body portion 31 are lined up on the rotation axis A, and infrared light sources and light receiving elements of the detecting portions 39 are also disposed on the rotation axis A. Therefore, wiring of the detecting portions 39 is facilitated. That is, since the holder portion 15 is brought into the rearwardly tilting holding state or the forwardly tilting waiting state due to the rotation of the rotational body portion 23, with the posture of the holder portion 15 differing for each state, the rotation axis A does not change in either state of the holder portion 15. If the positions of the detecting portions 39 inside the respective supporting body portions 16 are situated away from the rotation axis A, the positions of the detecting portions 39 with respect to the rotation axis A are displaced each time the state of the holder portion 15 changes, as a result of which wiring becomes troublesome. Therefore, by disposing the detecting portions 39 on the rotation axis A as in the present embodiment, wires are easily gathered.

In the present embodiment, since a plurality of holder portions 15 is disposed side by side in the left-right direction on the same rotation axis A, and rotational body portions 23 that are adjacent to each other are supported by a common supporting body portion 16 (see FIG. 5), the rotational body portions 23 can be separately rotated. That is, by individually rotating each holder portion 15 and bringing each holder portion 15 into the forwardly tilting waiting state or the rearwardly tilting holding state, only an instrument 6 that is to be used is brought into the forwardly tilting posture, and the other instruments 6 that are not used are maintained in the rearwardly tilting posture. Therefore, a plurality of instruments 6 can individually be smoothly, safely, and hygienically handled in accordance with whether or not they are to be used.

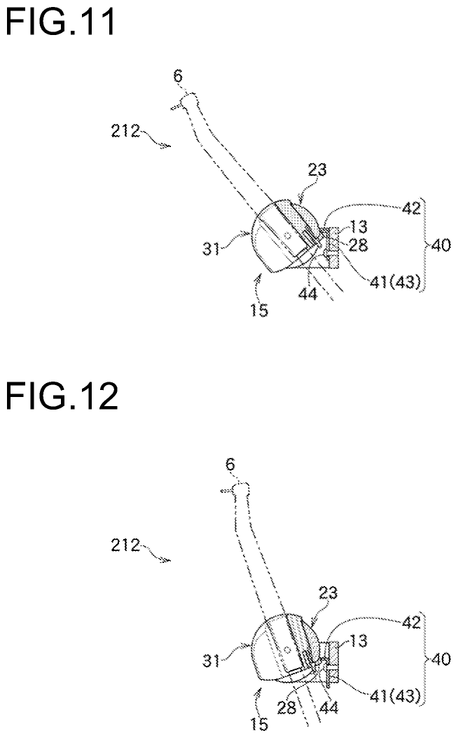

Next, a second embodiment of the present invention is described based on the drawings. An instrument holder according to the second embodiment differs from the instrument holder 12 according to the first embodiment in having forward tilt angle adjusting means. FIG. 11 and FIG. 12 show forward tilt angle adjusting means in an instrument holder 212 according to the second embodiment. In FIG. 11 and FIG. 12, the rotation angles of a holder portion 15 resulting from the forward tilt angle adjusting means differ from each other. In a forwardly tilting waiting state, a stopping angle of the holder portion 15 is any angle, and is determined by the forward tilt angle adjusting means.

As shown in FIG. 11 and FIG. 12, the forward tilt angle adjusting means is realized by an inverted L-shaped adjustment piece member 40 that is attached to a base portion 13, and a retain portion 28 of a rotational body portion 23. The adjustment piece member 40 has a first piece portion 41 that is fixed to the base portion 13 and a second piece portion 42 that is consecutively connected at right angles to the first piece portion 41. The first piece portion 41 has a long hole 43. With the first piece portion 41 in contact with a front surface of the base portion 13, a screw 44 is passed through the long hole 43, and the first piece portion 41 is fixed to the base portion 13. The second piece portion 42 protrudes forward from the base portion 13. Since the adjustment piece member 40 is capable of moving to any position with respect to the screw 44 in the range of the long hole 43, the position of the second piece portion 42 is determined by the position of the first piece portion 41 with respect to the base portion 13.

Since the retain portion 28 contacts the second piece portion 42 from therebelow, the rotational body portion 23 that rotates forward (counterclockwise rotation in FIG. 11 and FIG. 12) is stopped due to contact of the retain portion 28 with a lower surface of the second piece portion 42. Therefore, as shown in FIG. 11, when the position of the second piece portion 42 is relatively high, the position where the retain portion 28 contacts the second piece portion 42 is also high. Consequently, the rotation angle of the rotational body portion 23 is increased. That is, the amount of tilting of an end of an instrument 6 toward a side where a practitioner exists is increased. On the other hand, as shown in FIG. 12, when the position of the second piece portion 42 is relatively low, the position where the retain portion 28 contacts the second piece portion 42 is also low. Consequently, the rotation angle of the rotational body portion 23 is decreased. That is, the amount of tilting of an end of the instrument 6 toward the side where the practitioner exists is decreased.

Therefore, in the present embodiment, the practitioner is capable of adjusting a holder body portion 31 in the forwardly tilting waiting state at an angle that the holder body portion 31 can easily grasp the instrument 6.

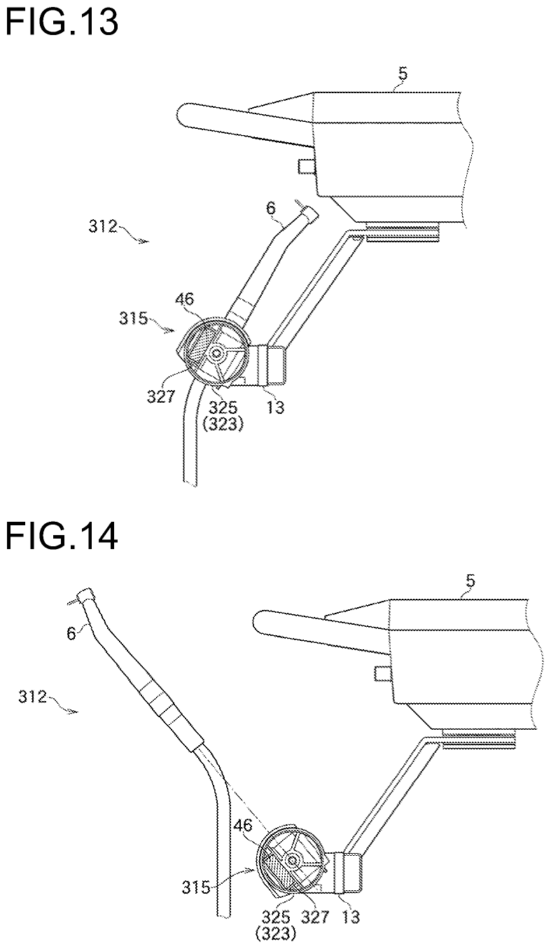

Next, a third embodiment of the present invention is described on the basis of the drawings. FIG. 13 and FIG. 14 show an instrument holder 312 according to the third embodiment. FIG. 13 shows a side view of a rearwardly tilting holding state of a holder portion 315 in a state in which a support portion 325 of a rotational body portion 323 is exposed, and FIG. 14 shows a forwardly tilting waiting state of the holder portion 315. The instrument holder 312 differs from the instrument holder 12 according to the first embodiment in having a weight 46 as state maintaining means. Note that the weight 46 may be made of any material and may have any shape.

As shown in FIG. 13 and FIG. 14, the weight 46 that becomes the center of gravity of the holder portion 315 is accommodated in a weight accommodation portion 327 of the rotational body portion 323 of the holder portion 315. Since the weight accommodation portion 327 is situated forward of the rotation axis A, the center of gravity of the rotational body portion 323 is situated more forward with respect to the rotation axis A than in the instrument holder 12 by a distance corresponding to the weight 46. Here, if the weight of the holder portion 315 can be ignored, the moment that acts upon the holder portion 315 including the weight 46 and an instrument 6 (hereunder referred to as “entire holder portion”) is determined by the weight of the weight 46 that is situated forward of the rotation axis A, the weight of the instrument 6 that is held on the rotation axis A, and the distance from the rotation axis A to each effort thereof.

For example, when the distance from the rotation axis A to the weight 46 and the distance from the rotation axis A to the center of gravity of the instrument 6 are the same and the weight that acts upon the instrument 6 is greater than the weight that acts upon the weight 46, or when the weights are the same and the distance from the rotation axis A to the center of gravity of the instrument 6 is larger than the distance from the rotation axis A to the center of gravity of the weight 46, or when the weight that acts upon the instrument 6 is smaller than the weight that acts upon the weight 46 and the distance from the rotation axis A to the center of gravity of the instrument 6 is larger than the distance from the rotation axis A to the center of gravity of the weight 46, the rearwardly tilting holding state is realized.

For example, when the distance from the rotation axis A to the weight 46 and the distance from the rotation axis A to the center of gravity of the instrument 6 are the same and the weight that acts upon the weight 46 is greater than the weight that acts upon the instrument 6, or when the weights are the same and the distance from the rotation axis A to the center of gravity of the weight 46 is larger than the distance from the rotation axis A to the center of gravity of the instrument 6, or when the weight that acts upon the weight 46 is smaller than the weight that acts upon the instrument 6 and the distance from the rotation axis A to the center of gravity of the weight 46 is larger than the distance from the rotation axis A to the center of gravity of the instrument 6, the forwardly tilting waiting state is realized.

On the basis of the conditions above, the instrument holder 312 is designed so that, in the rearwardly tilting holding state, the moment that acts upon the entire holder portion is in a direction of rearward rotation of the rotational body portion 323 (for example, clockwise in FIG. 13). On the other hand, the instrument holder 312 is designed so that, in the forwardly tilting waiting state, the moment that acts upon the entire holder portion is in a direction of forward rotation of the rotational body portion 323 (for example, counterclockwise in FIG. 14). Therefore, in the forwardly tilting waiting state, when the instrument 6 is held by the holder portion 315, the rotational body portion 323 rotates rearward, and the position of the center of gravity goes beyond the rotation axis A (hereunder, in the process of change between the rearwardly tilting holding state and the forwardly tilting waiting state, the position of the moment the position of the center of gravity moves beyond the rotation axis A is expressed as “critical position”), as shown in FIG. 13, the forwardly tilting waiting state changes to the rearwardly tilting holding state and this state is maintained. On the other hand, in the rearwardly tilting holding state, when the rotational body portion 323 rotates forward and moves beyond the critical position, as shown in FIG. 14, the rearwardly tilting holding state changes to the forwardly tilting waiting state and this state is maintained. The forwardly tilting waiting state does not change regardless of whether the instrument 6 is held by the holder portion 315 or whether the instrument 6 is not held by the holder portion 315.

Here, as long as the holder portion 315 is designed so that the moment that acts upon the entire holder portion is, in the rearwardly tilting holding state, in the direction of rearward rotation of the rotational body portion 323, and is, in the forwardly tilting waiting state, in the direction of forward direction of the rotational body portion 323, the instrument holder 312 may be such that the center of the holder portion 315 is slightly displaced in a front-back direction from the rotation axis A.

As described above, in the present embodiment, since the weight 46 is attached, as long as a case in which the center of gravity moves beyond the critical position due to the action of an external force that exceeds the gravitation that acts upon the center of gravity does not occur, the forwardly tilting waiting state is continued. Therefore, the holder portion is suppressed from unintentionally being brought into the rearwardly tilting holding state.

In the present embodiment, the holder portion 315 holding an instrument 6 maintains the rearwardly tilting holding state by the gravitation that acts upon the center of gravity of the instrument 6. In the rearwardly tilting holding state, since the instrument 6 is in a rearwardly tilting posture and is unlikely to contact a practitioner, the practitioner is capable of safely and hygienically handling the instrument 6. On the other hand, after the instrument 6 has been pulled out, the holder portion 315 maintains the forwardly tilting waiting state by the gravitation that acts upon the center of gravity of the weight 46. In the forwardly tilting waiting state, since the holder portion 315 faces a direction that allows the holder portion 315 to receive the instrument 6 in a forwardly tilting posture, the practitioner is capable of easily returning the instrument 6 to the holder portion 315 and smoothly handling the instrument 6. Further, even after returning the instrument 6, the practitioner is capable of allowing the instrument 6 to be held in the forwardly tilting waiting state in accordance with use.

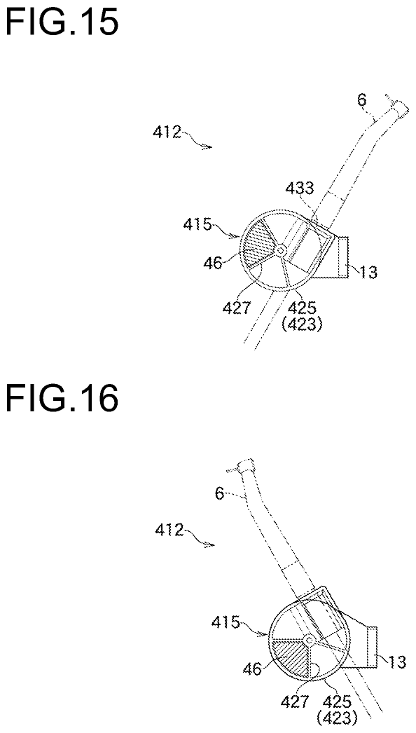

Next, an instrument holder according to a fourth embodiment of the present invention is described on the basis of the drawings. FIG. 15 and FIG. 16 show an instrument holder 412 according to the fourth embodiment. FIG. 15 shows a side view of a rearwardly tilting holding state of a holder portion 415 in a state in which a support portion 425 of a rotational body portion 423 is exposed, and FIG. 16 shows a forwardly tilting waiting state of the holder portion 415. The instrument holder 412 differs from those of the other embodiments in the structure of a weight 46 and the position where an instrument 6 is held.

As shown in FIG. 15 and FIG. 16, the weight 46 is accommodated in a weight accommodation portion 427 of the rotational body portion 423 of the holder portion 415. Since the weight accommodation portion 427 is situated forward of the rotation axis A, the center of gravity of the rotational body portion 423 is also situated forward of the rotation axis A due to the weight 46. On the other hand, the instrument 6 is inserted in an insertion hole 433 of the holder portion 415. The center of the insertion hole 433 is displaced rearward of the rotation axis A, and the center of gravity of the instrument 6 held by the holder portion 415 is situated rearward of the rotation axis A. Note that the moment that acts upon the entire holder portion is the same as that of the instrument holder 312 according to the third embodiment in being determined by the weight of the weight 46 that is situated forward of the rotation axis A, the weight of the instrument 6 that is held rearward of the rotation axis A, and the distance from the rotation axis A to each effort thereof.

The instrument holder 412 is brought into the rearwardly tilting holding state only when an instrument 6 is held by the holder portion 415, and is brought into the forwardly tilting waiting state only when an instrument 6 is not held by the holder portion 415. That is, as shown in FIG. 16, the instrument holder 412 is such that, in the forwardly tilting waiting state, as a result of holding the instrument 6 by the holder portion 415, the rotational body portion 423 automatically rotates rearward and moves beyond the critical position, and, as shown in FIG. 15, the forwardly tilting waiting state changes to the rearwardly tilting holding state and this state is maintained. In the rearwardly tilting holding state, when the rotational body portion 423 rotates forward and moves beyond the critical position, as shown in FIG. 16, the rearwardly tilting holding state changes to the forwardly tilting waiting state, and the forwardly tilting waiting state is maintained as a result of pulling out the instrument 6 from the holder portion 415. That is, when the instrument 6 is returned to the holder portion 415, the forwardly tilting waiting state automatically changes to the rearwardly tilting holding state.

As described above, in the present embodiment, the holder portion 415 holding an instrument 6 is automatically brought into the rearwardly tilting holding state from the forwardly tilting waiting state by the gravitation that acts upon the center of gravity of the instrument 6, and the rearwardly tilting holding state is maintained. Therefore, since the instrument 6 is not held in the forwardly tilting posture in which the instrument 6 may contact a practitioner, the practitioner is capable of safely and hygienically handling the instrument 6.

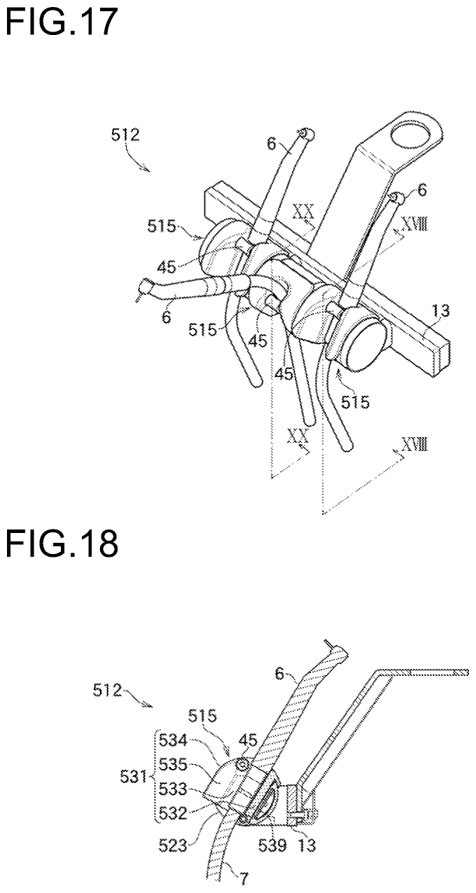

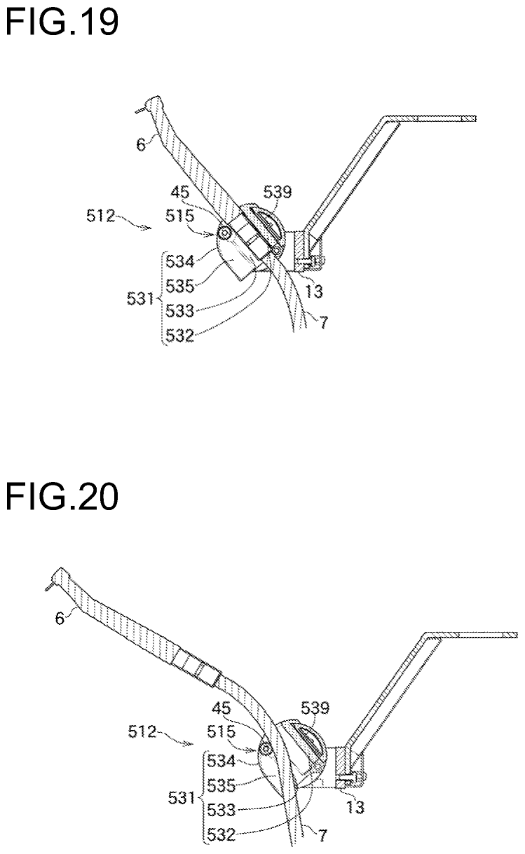

Next, a fifth embodiment of the present invention is described on the basis of the drawings. FIGS. 17, 18, 19, and 20 show an instrument holder 512 according to a fifth embodiment. FIG. 17 is an external view of the instrument holder 512, FIG. 18 shows a side cross section of a rearwardly tilting holding state, FIG. 19 shows a side cross section of a forwardly tilting waiting state, and FIG. 20 shows a side cross section of a state in which, in the forwardly tilting waiting state, an instrument 6 has been pulled out from a holder portion 515. The instrument holder 512 differs from the instrument holder 12 according to the first embodiment in that the holder portion 515 has a roller 45 that supports an instrument 6.

As shown in FIG. 17 and FIG. 18, the roller 45 is attached to a holder body portion 531 of the holder portion 515. The roller 45 is situated forward of an insertion hole 533 of a cylindrical portion 532, and is disposed at a part of an open portion 535. The roller 45 has a rod shape and has, as an axis of rotation, an axis parallel to the rotation axis A of a rotational body portion 523. The roller 45 is attachable and detachable. That is, during cleaning or the like, an instrument hose 7 passes through the open portion 535 as a result of removing the roller 45. As shown in FIG. 19 and FIG. 20, in the forwardly tilting waiting state, when an instrument 6 is to be pulled out, the instrument hose 7 is supported by the roller 45 and passes through the insertion hole 533. The instrument hose 7 is smoothly pulled out due to the distribution of a load by the roller 45 that rotates. A detecting portion 539 is, for example, a magnet sensor. A switch is built in the holder portion 515, and a magnetic body (not shown) is attached to the instrument 6.

As described above, in the present embodiment, the roller 45 is attached to the holder body portion 531 of the holder portion 515. Due to this structure, since the instrument hose 7 is supported by the roller 45 and the load is distributed due to the rotation of the roller 45, the operability of the instrument 6 is increased and the burden on a practitioner when pulling out the instrument 6 is reduced. In addition, since the instrument hose 7 passes between the holder body portion 531 and the roller 45, even when pulling out or returning the instrument 6, a path of the instrument hose 7 is restricted to the inside of the insertion hole 533 of the holder body portion 531, and the instrument hose 7 is not removed from the holder body portion 531. Therefore, the practitioner can easily return the instrument 6. In the present embodiment, since the rotational body portion 523 rotates separately, and the other instruments that are not used are in a rearwardly tilting posture, even if the path of the instrument hose 7 is restricted, the instrument hose 7 does not interfere with the other instruments 6. If the specification of the other instruments 6 is one in which a forwardly tilting posture does not change and the instrument hose 7 is restricted by the roller 45, since the path of the instrument hose 7 is limited to the vicinity of the other instruments in the forwardly tilting posture, the instrument hose 7 may get caught by the other instruments 6.

In the present embodiment, as the detecting portion 539, for example, a magnet sensor can be used regardless of the position of the rotation axis A.

Note that in another embodiment of the present invention, a single holder portion is provided instead of a plurality of holder portions.

In another embodiment, forward tilt angle adjusting means is not provided.

In another embodiment, a front surface of a holder portion is flat instead of having an arc shape.

In another embodiment, if an operation portion is not flat and has a shape that easily allows an external force to act due to contact therewith, the operation portion has any shape. The operation portion is, for example, an uneven portion, a rough surface, a protrusion, a hollow, or a hole.

In another embodiment, as long as a detecting portion and each window portion exist on the same line, the detecting portion and each window portion are disposed near the rotation axis or at positions that are situated away from the rotation axis instead of on the rotation axis. In this case, since the position of the detecting portion differs depending upon each state of a holder portion, a good way of wiring the detecting portion needs to be devised.

In another embodiment, a detecting portion is a reflective infrared sensor. In this case, the detecting portion is built in, for example, a rotational body portion or a supporting body portion.

In another embodiment, a detecting portion is a magnet sensor. In this case, each window portion is not formed, a sensor is built in a rotational body portion, and a magnetic body is built in an instrument. A sensor is built in a supporting body portion and this sensor detects magnetic force of an instrument.

In another embodiment, a detecting portion is a contact switch. In this case, the contact switch is disposed in an insertion hole of a holder body portion.

In another embodiment, a detecting portion is imaging means, such as a video camera.

In another embodiment, a holder portion does not have a detecting portion.

In another embodiment, state maintaining means is designed to cause the center of gravity of a rotational body itself to be at a predetermined position instead of having a structure in which a weight is accommodated in a weight accommodation portion.

In another embodiment, state maintaining means causes a moment to act by, for example, air, a pneumatic or hydraulic piston cylinder, a spring, or an electromagnet.

In another embodiment, state maintaining means is a suitable resistance provided between a supporting body portion and a rotational body portion, and stops the rotational body portion by frictional force. In this case, the rotational body portion stops at any position where the rotational body portion is freed from external force applied by, for example, a practitioner.

In another embodiment, a rotational body portion and a holder body portion are integrated with each other and such an integrated structure has a structure similar to a holder body portion at a rotational body portion.

In another structure, a state detecting portion that detects each state of a holder portion is provided at a base portion or a supporting body portion. The state detecting portion determines whether a holder portion is in a rearwardly tilting holding state or a forwardly tilting waiting state by detecting the position of a rotational body portion, and is, for example, an infrared sensor, a magnet sensor, a contact switch, or a tilt sensor. In this case, for example, only when detection of an instrument by a detecting portion and detection of the rearwardly tilting holding state by the state detecting portion are both in an ON state, control of, for example, outputting a signal can be performed.

Although embodiments of the present invention have been described in detail above, the present invention is not limited to the embodiments above. The present invention can be variously changed in terms of design as long as the changes do not depart from matters described in the claims.

### REFERENCE SIGNS LIST

1 dental treatment device
2 treatment seat
3 spittoon
4 dental light
doctor table
6 instrument
7 instrument hose (hose)
8 cuspidor unit
9 subholder
light movable arm
11 table movable arm
12, 212, 312, 412, 512 instrument holder
13 base portion
14 through wire hole
15, 315, 415, 515 holder portion
16 supporting body portion
17 fixed-side supporting body portion
18 cover-side supporting body portion
19 detecting-portion accommodation portion
connection portion
21 axial protrusion
22 supporting window portion
23, 323, 423, 523 rotational body portion
24 mount hole
25, 325, 425 support portion
26 back surface portion
27, 327, 427 weight accommodation portion
28 retain portion (forward tilt angle adjusting means)
29 rotational body window portion
30 transmissive member
31, 531 holder body portion
32, 532 cylindrical portion
33, 533 insertion hole
34, 534 cover portion
35, 535 open portion
36 holder window portion
37 retaining piece
38 decorative cover
39, 539 detecting portion
40 adjustment piece member (forward tilt angle adjusting means)
41 first piece portion
42 second piece portion
43 long hole
44 screw
45 roller
46 weight (state maintaining means)
47 positioning protrusion (angular positioning means)
48 positioning groove portion (angular positioning means)
49 first positioning portion
50 second positioning portion
51 axial recessed portion
52 curved outer surface portion
53 flat outer surface portion (operation portion)
A rotation axis
H horizontal line

1-13. (canceled)

14. An instrument holder comprising:
a holder portion that rotates from a rearwardly tilting holding state in a direction in which an instrument is brought into a forwardly tilting posture, and that is thereby brought into a forwardly tilting waiting state, the rearwardly tilting holding state being a state in which the holder portion holds the instrument in a rearwardly tilting posture in which an end of the instrument is tilted rearward, the forwardly tilting posture being a posture in which the end is tilted forward,
wherein after, in the forwardly tilting waiting state, the instrument is returned to the holder portion, the holder portion is brought into the rearwardly tilting holding state and the rearwardly tilting holding state is maintained.

15. The instrument holder according to claim 14, wherein the holder portion, due to action of an external force, is brought into the forwardly tilting waiting state from the rearwardly tilting holding state, and, in a state in which the instrument is removed from the holder portion, the forwardly tilting waiting state is maintained.

16. The instrument holder according to claim 14, wherein a plurality of the holder portions is separately rotatable.

17. The instrument holder according to claim 14, wherein the holder portion has a roller that supports a hose of the instrument removed from the holder portion.

18. The instrument holder according to claim 16, wherein a front surface of the holder portion is provided with a curved outer surface portion that is formed with an arc shape as seen from a direction of a rotation axis of the holder portion, and an operation portion upon which an external force for bringing the holder portion from the rearwardly tilting holding state to the forwardly tilting waiting state acts, and
wherein, of the holder portion in the rearwardly tilting holding state, the operation portion is situated above a horizontal line passing through the rotation axis of the holder portion.

19. The instrument holder according to claim 16, wherein a detecting portion that detects presence or absence of the instrument is provided on a rotation axis of the holder portion or near the rotation axis.

20. The instrument holder according to claim 16, wherein the forwardly tilting waiting state is maintained as a result of a center of gravity of the holder portion being situated forward of a rotation axis of the holder portion.

21. An instrument holder comprising:
a holder portion that rotates from a rearwardly tilting holding state in a direction in which an instrument is brought into a forwardly tilting posture, and that is thereby brought into a forwardly tilting waiting state, the rearwardly tilting holding state being a state in which the holder portion holds the instrument in a rearwardly tilting posture in which an end of the instrument is tilted rearward, the forwardly tilting posture being a posture in which the end is tilted forward,
wherein the holder portion is brought into the rearwardly tilting holding state from the forwardly tilting waiting state by holding the instrument at a position where a center of gravity of the instrument is situated rearward of a rotation axis of the holder portion.

22. The instrument holder according to claim 15, wherein a plurality of the holder portions is separately rotatable.

23. The instrument holder according to claim 22, wherein a front surface of the holder portion is provided with a curved outer surface portion that is formed with an arc shape as seen from a direction of a rotation axis of the holder portion, and an operation portion upon which an external force for bringing the holder portion from the rearwardly tilting holding state to the forwardly tilting waiting state acts, and
wherein, of the holder portion in the rearwardly tilting holding state, the operation portion is situated above a horizontal line passing through the rotation axis of the holder portion.

24. The instrument holder according to claim 22, wherein a detecting portion that detects presence or absence of the instrument is provided on a rotation axis of the holder portion or near the rotation axis.

25. The instrument holder according to claim 22, wherein the forwardly tilting waiting state is maintained as a result of a center of gravity of the holder portion being situated forward of a rotation axis of the holder portion.
